(19) United States
(12) Patent Application Publication
(10) Pub. No.: US 2011/0003167 A1
(43) Pub. Date: Jan. 6, 2011

(54) METALLIC MATERIAL FOR A CONNECTOR AND METHOD OF PRODUCING THE SAME

(76) Inventors: Shuichi KITAGAWA, Tokyo (JP); Kengo Mitose, Tokyo (JP); Yoshiaki Kobayashi, Tokyo (JP)

Correspondence Address: BIRCH STEWART KOLASCH & BIRCH, PO BOX 747, FALLS CHURCH, VA, 22040-0747, US

(21) Appl. No.: 12/884,268

(22) Filed: Sep. 17, 2010

Related U.S. Application Data
(63) Continuation of application No. PCT/JP2009/055358, filed on Mar. 18, 2009.

(30) Foreign Application Priority Data
Mar. 19, 2008 (JP) 2008-072545

(51) Int. Cl. B32B 3/00; B32B 15/01; B05D 3/00; B05D 3/06

(52) U.S. Cl. 428/600; 428/647; 427/331; 427/554

(57) ABSTRACT

A metallic material for a connector, having a base material of a bar material or a rectangular wire material formed of copper or a copper alloy, in which a striped copper-tin alloy layer is formed in the longitudinal direction of the metallic material on a part of the surface of the metallic material, and in which a tin layer or a tin alloy layer is formed on the remaining part of the surface of the metallic material; and, a method of producing a metallic material for a connector, containing: providing a bar material or a rectangular wire material of copper or a copper alloy as a base material; forming a tin plating layer or a tin alloy plating layer on the base material, to obtain an intermediate material; and subjecting the intermediate material to reflow treatment in a stripe form in the longitudinal direction of the intermediate material.

### TECHNICAL FIELD

The present invention relates to a metallic material for a connector and a method of producing the same, and specifically relates to a metallic material for a connector, which material is favorable in both the property of low plugging-in force and the connection reliability, and a method of producing the same.

### BACKGROUND ART

A plated material produced by providing a plating layer of, for example, tin (Sn) or a tin alloy, on an electroconductive base material, such as copper (Cu) or a copper alloy (hereinafter, appropriately referred to as base material), is known as a high performance conductor material having the excellent electroconductivity and mechanical strength of the base material, as well as the excellent electrical connectivity, corrosion resistance, and solderability of the plating layer. Thus, plated materials are widely used in various terminals, connectors, and the like.

In recent years, since a fitting-type connector is multipolarized with advancement of electronic control, a considerable force is necessary for plugging a group of male terminals into/out of a group of female terminals. In particular, plugging-in/out such a connector is difficult in a narrow space such as the engine room of the vehicle, and it has been strongly demanded to be able to reduce the force for plugging in/out such a connector.

In order to reduce the plugging-in/out force, the Sn plating layer on the surface of the connector terminal may be thinned to weaken contact pressure between the terminals. However, because the Sn plating layer is soft, a fretting phenomenon may occur between contact faces of the terminals, thereby causing inferior conduction between the terminals.

In the fretting phenomenon, the soft Sn plating layer on the surface of the terminal wears and is oxidized, becoming abrasion powder having large specific resistance, due to fine vibration between the contact faces of the terminals caused by vibration and changes in temperature. When this phenomenon occurs between the terminals, conduction between the terminals results in inferior. The lower the contact pressure between the terminals, the more the fretting phenomenon is apt to occur.

Patent Literature 1 describes a method of producing a fitting-type connection terminal, in which an underlying copper plating layer is formed on a base material of copper or a copper alloy, a tin plating layer is further formed on the surface thereof, then the face opposite to the sliding face in the fitting unit of the terminal is irradiated with a laser beam, so that the part corresponding to the beam spot of the laser in the sliding face is heated by heat transfer, and thereby a copper-tin alloy layer is formed at the interface between the tin plating layer and the underlying copper plating layer.

According to Patent Literature 1, it is believed that, under laser beam irradiation conditions that are capable of maintaining a thin tin plating layer, it is possible to decrease the plugging-in force of the terminal while maintaining the contact resistance stable; and further, since the tin plating layer is not directly irradiated with the laser beam, the tin plating layer does not undergo a change by fusion, and the contact resistance is not deteriorated.

Patent Literature 2 describes a fitting-type male terminal having a tin plated layer provided on the surface of a tab of the fitting-type male terminal where plugging marks are formed on the surface of the tabular tab of the fitting-type male terminal when brought into elastic contact with protruding parts formed so as to sandwich the tab within the fitting unit of a fitting-type female terminal, wherein the vicinity of the connection mark at the end of the plugging mark is surface-treated to have a plating thickness that is at least larger than that of the area where the plugging mark is formed.

In this fitting-type male terminal, the contact site where the connection mark is formed has a plating layer that is capable of securing connection reliability, and the plating layer of the area where the plugging mark is formed in the front part of the contact site, is thin. Thus, it is believed to make it possible to achieve both the effect of reducing a plugging-in force and the connection reliability.

However, in the foregoing fitting-type connection terminal, the solder wettability is decreased by heating through the back surface which is used in soldering, and the friction coefficient is high at the area where sliding occurs at the time of plugging-in. Therefore, it is still unsatisfactory in achieving both of the property of low plugging-in force and the connection reliability.

Patent Literature 1: JP-A-11-233228 (“JP-A” means unexamined published Japanese patent application)

### Patent Literature 2: JP-A-2005-353352

### DISCLOSURE OF INVENTION

### Technical Problem

It is an object of the present invention to provide a metallic material for a connector, which material is favorable in both of the property of low plugging-in force and the connection reliability, and to provide a method of producing the same.

### Solution to Problem

According to the present invention, there is provided the following means:

(1) A metallic material for a connector, having a base material of a bar material or a rectangular wire material formed of copper or a copper alloy, wherein a striped copper-tin alloy layer is formed in the longitudinal direction of the metallic material on a part of the surface of the metallic material, and wherein a tin layer or a tin alloy layer is formed on the remaining part of the surface of the metallic material;

(2) A metallic material for a connector, having: a base material of a bar material or a rectangular wire material formed of copper or a copper alloy; and a tin layer or a tin alloy layer formed on the surface of the base material, wherein the thickness of the tin layer or the tin alloy layer varies in a stripe form in the transverse direction of the metallic material, and wherein a copper-tin alloy layer is formed as an under layer at least the area where the thickness of the tin layer or the tin alloy layer is thin;

(3) The metallic material for a connector as described in the item (1) or (2), wherein a copper layer or a copper alloy layer is formed as an under layer of the tin layer or the tin alloy layer;

(4) The metallic material for a connector as described in any one of the items (1) to (3), wherein a nickel layer or a nickel alloy layer is formed on the base material;

(5) A method of producing a metallic material for a connector, comprising: providing a bar material or a rectangular wire material of copper or a copper alloy as a base material; forming a tin plating layer or a tin alloy plating layer on the base material, to obtain an intermediate material; and subjecting the intermediate material to reflow treatment in a stripe form in the longitudinal direction of the intermediate material;

(6) The method of producing a metallic material for a connector as described in the item (5), wherein the reflow treatment is carried out, to expose the copper-tin alloy partially at the surface;

(7) The method of producing a metallic material for a connector as described in the item (6), wherein the thickness of the tin plating layer or the tin alloy plating layer before subjecting to the reflow treatment is 0.3 to 0.8 μm;

(8) The method of producing a metallic material for a connector as described in the item (6), wherein the intermediate material is obtained, by providing a copper plating layer or a copper alloy plating layer between the base material and the tin plating layer or the tin alloy plating layer, or by providing, on the base material, a nickel plating layer or a nickel alloy plating layer, and a copper plating layer or a copper alloy plating layer, from the side nearer to the base material;

(9) The method of producing a metallic material for a connector as described in the item (8), wherein the thickness of the tin plating layer or the tin alloy plating layer before subjecting to the reflow treatment is 0.3 to 0.8 μm, and wherein the ratio (Sn thickness/Cu thickness) of the thickness of the tin plating or tin alloy plating layer (Sn thickness) to the thickness of the copper plating layer (Cu thickness) is less than 2;

(10) The method of producing a metallic material for a connector as described in the item (5), wherein the reflow treatment is carried out, to form a copper-tin alloy layer, thereby to reduce the thickness of the tin plating layer or the tin alloy plating layer;

(11) The method of producing a metallic material for a connector as described in the item (10), wherein the thickness of the tin plating layer or the tin alloy plating layer before subjecting to the reflow treatment is 0.8 to 1.2 μm;

(12) The method of producing a metallic material for a connector as described in the item (10), wherein the intermediate material is obtained, by providing a copper plating layer or a copper alloy plating layer between the base material and the tin plating layer or the tin alloy plating layer, or by providing, on the base material, a nickel plating layer or a nickel alloy plating layer, and a copper plating layer or a copper alloy plating layer, from the side nearer to the base material;

(13) The method of producing a metallic material for a connector as described in the item (12), wherein the thickness of the tin plating layer or the tin alloy plating layer before subjecting to the reflow treatment is 0.8 to 1.2 μm, and wherein the ratio (Sn thickness/Cu thickness) of the thickness of the tin plating or tin alloy plating layer (Sn thickness) to the thickness of the copper plating layer (Cu thickness) is 2 or greater; and

(14) The method of producing a metallic material for a connector as described in any one of the items (5) to (13), wherein the reflow treatment is carried out by laser beam irradiation.

Hereinafter, a first embodiment of the present invention means to include the metallic material for a connector, as described in the items (1), and (3) to (4) {limited to those directly or indirectly dependent on the item (1)}, and the method of producing a metallic material for a connector, as described in the items (5), (6) to (9), and (14) {among these, limited to those directly or indirectly dependent on the items (5) and (6)}.

Further, a second embodiment of the present invention means to include the metallic material for a connector, as described in the items (2), and (3) to (4) {limited to those directly or indirectly dependent on the item (2)}, and the method of producing a metallic material for a connector, as described in the items (5), (10) to (13), and (14) {among these, limited to those directly or indirectly dependent on the items (5) and (10)}.

Herein, the present invention means to include all of the above first and second embodiments, unless otherwise specified.

### ADVANTAGEOUS EFFECTS OF INVENTION

The metallic material for a connector, of the present invention, in which a layer of tin or tin alloy plating and a copper-tin alloy layer appears in the transverse direction of the bar material (including a sheet material) or the rectangular wire material (including a rectangular rod material), can reduce the coefficient of friction, as compared with the case in which only a layer of tin or tin alloy plating is exposed. Further, the metallic material for a connector, of the present invention, in which a thick layer and a thin layer of tin or tin alloy plating appears in the transverse direction of the bar material or rectangular wire material, can reduce the coefficient of friction, as compared with the case in which only a thick layer is present. When a part of this copper-tin alloy layer or a part of this thin layer of tin plating is used at the contact site, the resultant material has a low coefficient of friction and is excellent in fretting resistance, and the remaining part other than the above is excellent in solderability or environment resistance. Thus, a connector can be formed, which is favorable in both of the low plugging-in force and the connection reliability.

Further, according to the method of producing a metallic material for a connector, of the present invention, since an intermediate material in which the base material is provided with plating is obtained and the intermediate material is subjected to reflow treatment in a stripe form in the longitudinal direction, the metallic material for a connector can be obtained, which has a very good productivity and is favorable in both of the low plugging-in force and the connection reliability.

Other and further features and advantages of the invention will appear more fully from the following description, appropriately referring to the accompanying drawings.

### BRIEF DESCRIPTION OF THE DRAWINGS

FIG. 1 is an enlarged schematic cross-sectional view of a metallic material for a connector (rectangular wire material) of Example 1.

FIG. 2 is an enlarged schematic cross-sectional view further enlarging the surface region of the metallic material for a connector (rectangular wire material), as shown in FIG. 1.

FIG. 3 is an enlarged schematic cross-sectional view of a metallic material for a connector (rectangular wire material) of Example 3.

FIG. 4 is an enlarged schematic cross-sectional view further enlarging the surface region of the metallic material for a connector (rectangular wire material), as shown in FIG. 3.

FIG. 5 is an enlarged schematic cross-sectional view of a rectangular wire material of Comparative example 1.

FIG. 6 is an enlarged schematic cross-sectional view further enlarging the surface region of the rectangular wire material, as shown in FIG. 5.

FIG. 7 is an enlarged schematic cross-sectional view of a rectangular wire material of Comparative example 2.

FIG. 8 is an enlarged schematic cross-sectional view further enlarging the surface region of the rectangular wire material, as shown in FIG. 6.

FIG. 9 is an enlarged schematic cross-sectional view of a metallic material for a connector (rectangular wire material) of Example 8.

FIG. 10 is an enlarged schematic cross-sectional view further enlarging the surface region of the metallic material for a connector (rectangular wire material), as shown in FIG. 9.

FIG. 11 is an enlarged schematic cross-sectional view of a metallic material for a connector (rectangular wire material) of Example 10.

FIG. 12 is an enlarged schematic cross-sectional view further enlarging the surface region of the metallic material for a connector (rectangular wire material), as shown in FIG. 11.

FIG. 13 is an enlarged schematic cross-sectional view of a rectangular wire material of Comparative example 3.

FIG. 14 is an enlarged schematic cross-sectional view further enlarging the surface region of the rectangular wire material, as shown in FIG. 13.

FIG. 15 is an enlarged schematic cross-sectional view of a rectangular wire material of Comparative example 4.

FIG. 16 is an enlarged schematic cross-sectional view further enlarging the surface region of the rectangular wire material, as shown in FIG. 15.

### DESCRIPTION OF REFERENCE NUMERALS

1 Base material and copper plating layer
   1a Base material
   1b Copper plating layer
2 Tin plating layer
3 Copper-tin alloy layer
4 Nickel plating layer
11 Base material and nickel plating layer
   11a Base material
   11b Copper plating layer
   11c Nickel plating layer
12 Tin plating layer
13 Copper-tin alloy layer

### BEST MODE FOR CARRYING OUT THE INVENTION

The metallic material for a connector, according to one preferred embodiment (the “first embodiment”) of the present invention, is one which has a bar material or a rectangular wire material formed of copper or a copper alloy as a base material, which has a striped copper-tin alloy layer formed in the longitudinal direction of the metallic material on a part of the surface of the metallic material, and which has a tin layer or a tin alloy layer formed on the remaining part of the surface of the metallic material.

The metallic material for a connector, according to another preferred embodiment (the “second embodiment”) of the present invention, is one which has a bar material or a rectangular wire material formed of copper or a copper alloy as a base material, which has a tin layer or a tin alloy layer formed on the surface of the base material, in which the thickness of the tin layer or the tin alloy layer varies in a stripe form in the transverse direction (lateral direction) of the metallic material, and in which a copper-tin alloy layer is formed as an under layer at least the area where the thickness of the tin layer or the tin alloy layer is thin.

As the base material for the metallic material for a connector, of the present invention, copper or a copper alloy is used, and use may be preferably made of copper and copper alloys, such as phosphor bronze, brass, nickel silver, beryllium copper, and Corson alloy, each of which has the electroconductivity, mechanical strength, and heat resistance required in connectors.

The shape of the base material is preferably a bar material (including a sheet material) or a rectangular wire material (including a rectangular rod material), and more preferably a rectangular wire material. For the rectangular wire material, the cross-sectional shape may be any of square, rectangle, and regular hexagon, or may be an irregularly shaped wire. A rectangular wire material having an approximately square cross-sectional shape can be used with preference in the present invention.

In the present invention, it is preferable to carry out Cu underlying plating on the rectangular wire material, and to provide a Cu plating layer, but a constitution, such as one capable of forming a copper-tin alloy by reflow that will be described later, may be used without any underlying. When a Cu plating layer is provided, the formation of a Cu—Sn alloy layer with a reduced Cu concentration can be readily achieved. The thickness of the Cu plating layer is preferably 0.01 to 3.0 μm, and more preferably 0.05 to 1.0 μm.

Further, in order to enhance heat resistance, a nickel plating layer may be formed, by providing a nickel (Ni) underlying plating having a barrier property that prevents the diffusion of metal from the lower layer, between the base material and the copper underlying. The nickel underlying plating may be a Ni alloy plating, such as a Ni—P-based, a Ni—Sn-based, a Co—P-based, a Ni—Co-based, a Ni—Co—P-based, a Ni—Cu-based, a Ni—Cr-based, a Ni—Zn-based, or a Ni—Fe-based. Ni and Ni alloys are not deteriorated in the barrier function even in a high temperature environment.

When the thickness of the nickel plating layer is less than 0.02 μm, the barrier function is not exhibited sufficiently, and when the thickness is greater than 3.0 μm, the plating strain is increased, and the plating layer is apt to be peeled off from the base material. Therefore, the thickness of the nickel plating layer is preferably 0.02 to 3.0 μm. The upper limit of the thickness of the nickel plating layer is preferably 1.5 μm, and more preferably 1.0 μm, taking the terminal processability into consideration.

In the present invention, the surface layer of the material is provided with tin plating or with tin alloy plating, and matt tin plating or tin alloy plating is preferable to glossy plating since the matt plating increases the absorptance of laser beam.

Further, if the thickness of the tin plating or tin alloy plating is too small, the heat resistance and environment resistance of tin are hardly exhibited. Thus, in the metallic material of the first embodiment, the thickness is preferably 0.3 μm or greater, more preferably 0.3 to 0.8 μm, and further preferably 0.3 to 0.6 μm. Further, in the metallic material of the second embodiment, the thickness is preferably 0.3 μm or greater, more preferably 0.8 to 1.2 μm, and further preferably 0.8 to 1.0 μm.

In the present invention, the tin plating may be formed by performing electroless plating, but it is preferable to form the tin plating by electroplating. Further, as the Sn alloy plating, plating of a Sn-based alloy, such as Sn—Cu, Sn—Bi, Sn—Ag, Sn—Zn, Sn—In, Sn—Pb, or Sn—Ag—Cu, can be used with preference.

The Sn electroplating of the surface layer may be performed by, for example, using a tin sulfate bath, at a plating temperature of 30° C. or lower, with a current density of 5 A/dm². The conditions are not limited thereto and can be appropriately set up.

In the production of the metallic material of the first embodiment, when an underlying copper plating is provided, the ratio (Sn thickness/Cu thickness) of the thickness of the surface layer tin plating or tin alloy plating layer (Sn thickness) to the thickness of the underlying copper plating layer (Cu thickness) is preferably less than 2, and more preferably equal to or greater than 1.0 and less than 2.0.

Further, in the production of the metallic material of the second embodiment, when an underlying copper plating is provided, the ratio (Sn thickness/Cu thickness) of the thickness of the surface layer tin plating or tin alloy plating layer (Sn thickness) to the thickness of the underlying copper plating layer (Cu thickness) is preferably 2 or greater, and more preferably 2.0 to 3.0.

The metallic material of the present invention for connectors is subjected to a reflow treatment in a stripe form in the longitudinal direction of the bar material or rectangular wire material having a tin plating or tin alloy plating layer formed as the outermost layer by the plating described above. Further, in the present invention, the stripe form means a continuous region having a narrower width than the width of one face of the bar material or rectangular wire material. The reflow treatment is not limited as long as the treatment is a method capable of performing reflow in a limited manner, to have a narrower width than one face of the bar material or rectangular wire material, and for example, a treatment by laser beam irradiation can be preferably used. When a treatment by laser beam irradiation is applied, it is advantageous in the point that the site irradiated with laser beam is limitedly reflowed. This treatment can be carried out by, for example, heating in a stripe form, using a YAG laser irradiating apparatus or a semiconductor laser irradiating apparatus, which are used in material processing.

In the production of the metallic material of the first embodiment, this treatment results in the formation of reflow stripes, and the copper-tin alloy is exposed at a part of the surface of the bar material or rectangular wire material. The proportion of the area occupied by the exposed copper-tin alloy at the surface of the material is preferably 20 to 80% when the material is a rectangular wire material.

Further, in the production of the metallic material of the second embodiment, this treatment results in the formation of reflow stripes, and the thickness of the tin layer or tin alloy layer varies in a stripe form in the transverse direction (lateral direction) of the metallic material, so that a copper-tin alloy layer is formed as an under layer at least the area where the thickness of the tin layer or tin alloy layer is small.

In the present invention, for example, in the case of rectangular wire, the reflow treatment as described above may be carried out on at least one face, but when the rectangular wire has been processed to the shape of a connector, it is preferable to take the reflow-treated face as a sliding face (a face for contact with the connector of the object to be connected).

The number of reflow stripes is 1 or more, and preferably 4 to 8. Further, the number of reflow stripes per face of the bar material or rectangular wire material to be used is preferably 1 to 2. However, the end area of the rectangular material is generally not provided with reflow stripes.

Hereinafter, the reflow treatment carried out using laser beam irradiation will be explained.

With respect to the conditions for laser beam irradiation, in the production of the metallic material of the first embodiment, the reflow treatment is carried out under such conditions that the Cu—Sn alloy would be exposed even at the surface. Further, in the production of the metallic material of the second embodiment, the reflow treatment is carried out under such conditions for laser beam irradiation that a thin Sn plating or Sn alloy plating layer would remain on the surface, and the thickness of the site with the thinnest Sn plating or Sn alloy plating layer at the surface is preferably 0.1 to 0.3 μm. In the present invention, the laser output power is preferably 1 W to 60 W.

In the present invention, the beam diameter (spot diameter) of the laser beam is preferably smaller than the width of the bar material to be used or the diameter or one side of the wire material, and larger than ⅕ of the width of the bar material or the diameter or one side of the wire material. The beam diameter of the laser beam is more preferably ⅕ to ⅘ in total of the width of the bar material or the diameter or one side of the wire material.

The depth of reflow achieved by the laser beam irradiation as described above is, if an underlying plating layer has been provided, adjusted to be shallower than the total thickness of plating provided on the material, and to be deeper than the thickness of the tin plating.

Further, in order to prevent the reflow treatment from being achieved in excess, laser beam irradiation may be carried out while the material is cooled from the side opposite to the side irradiated with laser beam.

The laser beam treatment may be carried out in the air, but may also be carried out under a reducing atmosphere.

The material for connectors, of the present invention, can be processed in a usual manner, into various electrical/electronic connectors including, for example, fitting-type connectors and contacts for automobiles. When the area of the copper-tin alloy layer exposed at the surface is used for the contact position in a fitted state, the exposed areas have a low coefficient of friction and are excellent in fretting resistance, while the areas other than the above are excellent in solderability or environment resistance. Thus, a connector favorable in both of the low plugging-in force and the connection reliability, can be formed.

### EXAMPLES

The present invention will be described in more detail based on examples given below, but the invention is not meant to be limited by these.

In the following Examples and Comparative Examples, copper plating was carried out using a sulfuric acid bath, nickel plating was carried out using a sulfamic acid bath, and tin plating was carried out using a sulfuric acid bath.

### Example 1

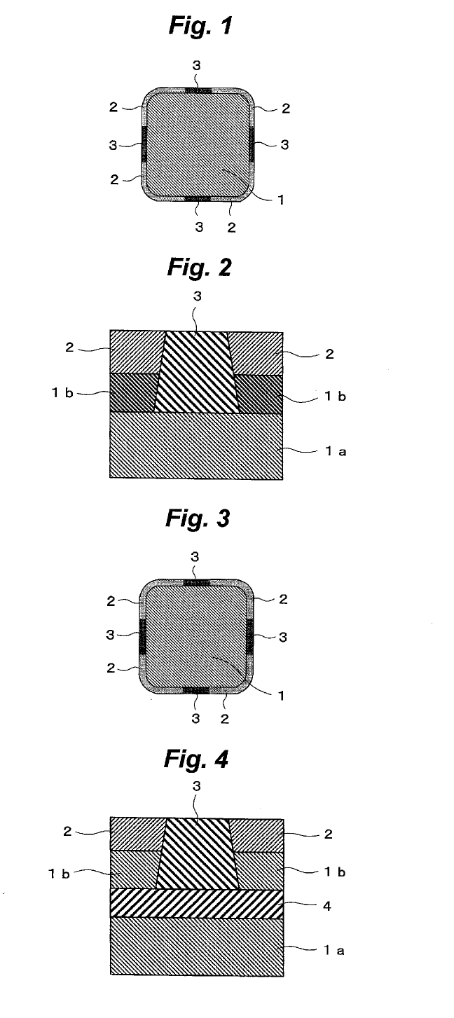

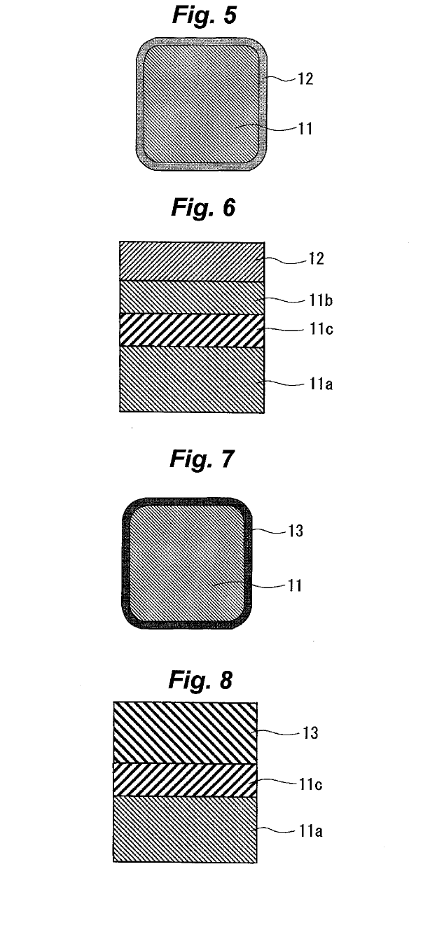

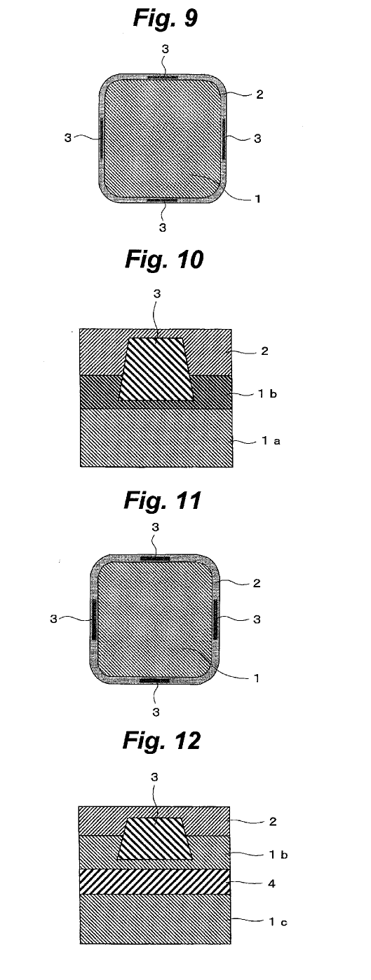

A 7/3 brass rectangular wire with width 0.64 mm (manufactured by Furukawa Electric Co., Ltd., material according to JIS Standard C2600: hereinafter, the same) was provided with an underlying plating of copper with thickness 0.3 μm, and then tin plating was conducted with thickness 0.3 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material, as shown in the enlarged schematic cross-sectional view of FIG. 1. In FIG. 1, the reference numeral 1 denotes a base material (brass rectangular wire) and a copper plating layer, the reference numeral 2 denotes a tin plating layer, and the reference numeral 3 denotes a copper-tin alloy layer. At the surface of the area irradiated with the laser beam, the copper-tin alloy layer 3 was exposed.

FIG. 2 is an enlarged schematic cross-sectional view which schematically shows a further enlarged view of the surface area including the copper-tin alloy layer of the rectangular wire material shown in FIG. 1. In the figure, the reference numeral 1a denotes the base material, the reference numeral 1b denotes a copper plating layer, the reference numeral 2 denotes a tin plating layer, and the reference numeral 3 denotes the copper-tin alloy layer.

### Example 2

A rectangular wire of Corson alloy (trade name: EFTEC-97, manufactured by Furukawa Electric Co., Ltd.: hereinafter, the same) with width 0.64 mm was provided with an underlying plating of copper with thickness 0.5 μm, and then tin plating was conducted with thickness 0.6 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material. At the surface of the area irradiated with the laser beam, the copper-tin alloy layer was exposed.

### Example 3

A 7/3 brass rectangular wire with width 0.64 mm was provided with an underlying plating of nickel with thickness 0.5 μm and an underlying plating of copper with thickness 0.3 μm, and then tin plating was conducted with thickness 0.3 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material, as shown in the enlarged schematic cross-sectional view of FIG. 3. In FIG. 3, the reference numeral 1 denotes a base material (brass rectangular wire) and a copper plating layer, the reference numeral 2 denotes a tin plating layer, and the reference numeral 3 denotes a copper-tin alloy layer. At the surface of the area irradiated with the laser beam, the copper-tin alloy layer was exposed.

FIG. 4 is an enlarged schematic cross-sectional view which schematically shows a further enlarged view of the surface area including the copper-tin alloy layer of the rectangular wire material shown in FIG. 3. Descriptions are omitted in FIG. 3, but as shown in FIG. 4, a nickel plating layer 4 is present between the base material 1a and the copper plating layer 1b.

### Example 4

A rectangular wire of Corson alloy with width 0.64 mm was provided with an underlying plating of nickel with thickness 0.5 μm and an underlying plating of copper with thickness 0.5 μm, and then tin plating was conducted with thickness 0.6 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material. At the surface of the area irradiated with the laser beam, the copper-tin alloy layer was exposed.

### Example 5

A 7/3 brass rectangular wire with width 0.64 mm was provided with an underlying plating of nickel with thickness 0.3 μm and an underlying plating of copper with thickness 0.3 μm, and then tin plating was conducted with thickness 0.3 μm. Then, the material was irradiated at the center in the transverse direction on each face, with a semiconductor laser (output power 5 W, wavelength 915 nm) having a beam diameter adjusted to ⅓ of the wire diameter, along the longitudinal direction of the material, to obtain a rectangular wire material. At the surface of the area irradiated with laser beam, the copper-tin alloy layer was exposed.

### Example 6

A rectangular wire of Corson alloy with width 0.64 mm was provided with an underlying plating of nickel with thickness 0.3 μm and an underlying plating of copper with thickness 0.5 μm, and then tin plating was conducted with thickness 0.6 μm. Then, the material was irradiated at the center in the transverse direction on each face, with a semiconductor laser (output power 5 W, wavelength 915 nm) having a beam diameter adjusted to ⅓ of the wire diameter, along the longitudinal direction of the material, to obtain a rectangular wire material. At the surface of the area irradiated with laser beam, the copper-tin alloy layer was exposed.

### Example 7

A 7/3 brass rectangular wire with width 0.64 mm was provided with an underlying plating of nickel with thickness 0.5 μm and an underlying plating of copper with thickness 0.3 μm and then tin plating was conducted with thickness 0.3 μm. Then, the material was irradiated at the center in the transverse direction on each surface, with a semiconductor laser (output power 5 W, wavelength 915 nm) with beam diameter 0.10 mm, along the longitudinal direction of the material to conduct reflow, to obtain a rectangular wire material. At the surface of the area irradiated with laser beam, the copper-tin alloy layer was exposed.

### Comparative Example 1

A 7/3 brass rectangular wire with width 0.64 mm was provided with an underlying plating of nickel with thickness 0.5 μm and an underlying plating of copper with thickness 0.3 μm, and then tin plating was conducted with thickness 0.3 μm, to obtain a rectangular wire material, as shown in an enlarged schematic cross-sectional view of FIG. 5. In FIG. 5, the reference numeral 11 denotes a base material (brass rectangular wire) and an underlying layer, and the reference numeral 12 denotes a tin plating layer.

FIG. 6 is an enlarged schematic cross-sectional view which schematically shows a further enlarged view of the surface area of the rectangular wire material shown in FIG. 5. In the figure, the reference numeral 11a denotes the base material, the reference numeral 11b denotes a copper plating layer, the reference numeral 11c denotes a nickel plating layer, and the reference numeral 12 denotes the tin plating layer.

### Comparative Example 2

A 7/3 brass rectangular wire with width 0.64 mm was provided with an underlying plating of nickel with thickness 0.5 μm and an underlying plating of copper with thickness 0.3 μm, and then tin plating was conducted with thickness 0.3 μm. Then, the resultant material was heated to the melting point or higher of Sn with a burner, to conduct reflow, thereby to obtain a rectangular wire material, as shown in the enlarged schematic cross-sectional view of FIG. 7. In FIG. 7, the reference numeral 11 denotes the base material (brass rectangular wire) and the underlying plating layer, and the reference numeral 13 denotes the copper-tin alloy layer.

FIG. 8 is an enlarged schematic cross-sectional view which schematically shows a further enlarged view of the surface area of the rectangular wire material shown in FIG. 7. In the figure, the reference numeral 11a denotes the base material, the reference numeral 11c denotes a nickel plating layer, and the reference numeral 13 denotes the copper-tin alloy layer.

### Example 8

A 7/3 brass rectangular wire with width 0.64 mm was provided with an underlying plating of copper with 0.3 μm, and then tin plating was conducted with 0.8 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material, as shown in the enlarged schematic cross-sectional view of FIG. 9. In FIG. 9, the reference numeral 1 denotes a base material (brass rectangular wire) and a copper plating layer, the reference numeral 2 denotes a tin plating layer, and the reference numeral 3 denotes a copper-tin alloy layer. The tin plating layer 2 at the area irradiated with the laser beam remained at the surface in the state of having a reduced thickness as compared with areas other than the above, and the copper-tin alloy layer 3 was formed beneath the tin plating layer.

FIG. 10 is an enlarged schematic cross-sectional view which schematically shows a further enlarged view of the surface area including the copper-tin alloy layer of the rectangular wire material shown in FIG. 9. In FIG. 10, the reference numeral 1a denotes the base material, the reference numeral 1b denotes a copper plating layer, the reference numeral 2 denotes a tin plating layer, and the reference numeral 3 denotes the copper-tin alloy layer.

### Example 9

A rectangular wire of Corson alloy with width 0.64 mm was provided with an underlying plating of copper with 0.5 μm, and then tin plating was conducted with 1.2 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material. At the surface of the area irradiated with the laser beam, the tin plating layer remained with a reduced thickness.

### Example 10

A 7/3 brass rectangular wire with width 0.64 mm was provided with an underlying plating of nickel with 0.5 μm and an underlying plating of copper with 0.3 μm and then tin plating was conducted with 0.8 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material, as shown in the enlarged schematic cross-sectional view of FIG. 11. In FIG. 11, the reference numeral 1 denotes a base material (brass rectangular wire) and a copper plating layer, the reference numeral 2 denotes a tin plating layer, and the reference numeral 3 denotes a copper-tin alloy layer. The tin plating layer 2 at the area irradiated with the laser beam remained at the surface in the state of having a reduced thickness as compared with areas other than the above, and the copper-tin alloy layer 3 was formed beneath the tin plating layer.

FIG. 12 is an enlarged schematic cross-sectional view which schematically shows a further enlarged view of the surface area including the copper-tin alloy layer of the rectangular wire material shown in FIG. 11. Descriptions are omitted in FIG. 11, but as shown in FIG. 12, a nickel plating layer 4 is present between the base material 1a and the copper plating layer 1b.

### Example 11

A rectangular wire of Corson alloy with width 0.64 mm was provided with an underlying plating of nickel with 0.5 μm and an underlying plating of copper with 0.5 μm, and then tin plating was conducted with 1.2 μm. Then, the resultant material was irradiated at the center in the transverse direction on each face, with a YAG laser with beam diameter 0.2 mm (output power 30 W, wavelength 1,064 nm) in the longitudinal direction of the material to conduct reflow, to obtain a rectangular wire material. At the surface of the area irradiated with the laser beam, the tin plating layer remained with a reduced thickness.

### Example 12

A 7/3 brass rectangular wire with width 0.64 mm was provided with an underlying plating of nickel with 0.3 μm and an underlying plating of copper with 0.3 μm, and then tin plating was conducted with 0.8 μm. Then, the material was irradiated at the center in the transverse direction on each surface, with a semiconductor laser (output power 5 W, wavelength 915 nm) having a beam diameter adjusted to ⅓ of the wire diameter, along the longitudinal direction of the material, to obtain a rectangular wire material. At the surface of the area irradiated with the laser beam, the tin plating layer remained with a reduced thickness.

### Example 13

A rectangular wire of Corson alloy with width 0.64 mm was provided with an underlying plating of nickel with 0.3 μm and an underlying plating of copper with 0.5 μm and then tin plating was conducted with 1.2 μm. Then, the resultant material was irradiated at the center in the transverse direction on each face, with a semiconductor laser (output power 5 W, wavelength 915 nm) having a beam diameter adjusted to ⅓ of the wire diameter, in the longitudinal direction of the material, to obtain a rectangular wire material. At the surface of the area irradiated with the laser beam, the tin plating layer remained with a reduced thickness.

### Example 14

A 7/3 brass rectangular wire with width 0.64 mm was provided with an underlying plating of nickel with 0.5 μm and an underlying plating of copper with 0.3 μm and then tin plating was conducted with 0.8 μm. Then, the material was irradiated at the center in the transverse direction on each surface, with a semiconductor laser (output power 5 W, wavelength 915 nm) with beam diameter 0.10 mm, along the longitudinal direction of the material to conduct reflow, to obtain a rectangular wire material. At the surface of the area irradiated with the laser beam, the tin plating layer remained with a reduced thickness.

### Comparative Example 3

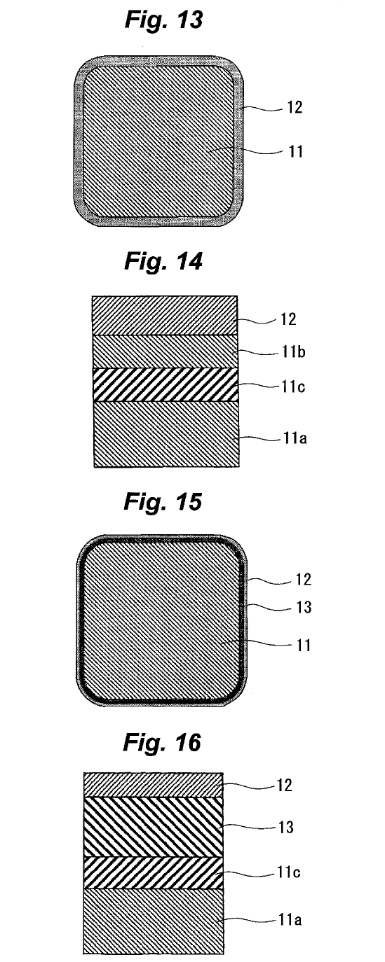

A 7/3 brass rectangular wire with width 0.64 mm was provided with an underlying plating of nickel with 0.5 μm and an underlying plating of copper with 0.3 μm and then tin plating was conducted with 0.8 μm, to obtain a rectangular wire material, which thus-obtained rectangular wire material is shown in an enlarged schematic cross-sectional view of FIG. 13. In FIG. 13, the reference numeral 11 denotes a base material (brass rectangular wire) and an underlying plating layer, and the reference numeral 12 denotes a tin plating layer.

FIG. 14 is an enlarged schematic cross-sectional view which schematically shows a further enlarged view of the surface area of the rectangular wire material shown in FIG. 13. In the figure, the reference numeral 11a denotes the base material, the reference numeral 11b denotes a copper plating layer, the reference numeral 11c denotes a nickel plating layer, and the reference numeral 13 denotes the tin plating layer.

### Comparative Example 4

A 7/3 brass rectangular wire with width 0.64 mm was provided with an underlying plating of nickel with 0.5 μm and an underlying plating of copper with 0.3 μm, and then tin plating was conducted with 0.8 μm. Then, the resultant material was heated to the melting point or higher of Sn with a burner, to conduct reflow, thereby to obtain a rectangular wire material, as shown in the enlarged schematic cross-sectional view of FIG. 15. In FIG. 15, the reference numeral 11 denotes a base material (brass rectangular wire) and an underlying plating layer, the reference numeral 12 denotes a tin plating layer, and the reference numeral 13 denotes the copper-tin alloy layer. A thin tin plating layer 22 covered the entire surface.

FIG. 16 is an enlarged schematic cross-sectional view which schematically shows a further enlarged view of the surface area of the rectangular wire material shown in FIG. 15. In the figure, the reference numeral 11a denotes the base material, the reference numeral 11c denotes a nickel plating layer, the reference numeral 12 denotes a tin plating layer, and the reference numeral 13 denotes the copper-tin alloy layer.

### Test Example

The rectangular wire materials of Examples 1 to 14 and Comparative examples 1 to 4 were subjected to evaluation tests on contact resistance, solder wettability, and coefficient of kinetic friction.

### (Contact Resistance)

The contact resistance was measured according to a four-terminal method. An Ag probe was used for a contact, and the measurement was made under a load of 1 N.

A contact resistance of 2 mΩ or less was designated to as good ∘∘, a contact resistance of 5 mΩ or less was designated to as acceptable (passed the test) ∘, and a higher contact resistance was designated to as unacceptable x.

### (Solder Wettability)

The solder wettability was measured according to a meniscograph method.

Solder Checker SAT-5100, manufactured by Rhesca Corp., was used for the apparatus.

Lead-free solder of Sn-3.0Ag-0.5Cu was used as the solder, and a 25% rosin flux was used.

The determination criteria were as follows: good ∘∘ when 95% or more of the immersed area was wet, acceptable ∘ when 90% or more of the immersed area was wet, and unacceptable x when the wet area was less than that.

### (Coefficient of Kinetic Friction)

A Bowden tester was used for the measurement of the coefficient of kinetic friction.

The measurement was made with a sliding contact provided with dimples as a model of a group of female terminals.

The determination criteria were as follows: good ∘∘ when μk<0.25, acceptable ∘ when μk<0.3, and unacceptable x when μk was 0.3 or more.

TABLE 1

| | Contact | Solder | Coefficient of |
|---|---|---|---|
| | resistance | wettability | kinetic friction |
| Example 1 | ∘ | ∘ | ∘∘ |
| Example 2 | ∘ | ∘ | ∘∘ |
| Example 3 | ∘ | ∘ | ∘∘ |
| Example 4 | ∘∘ | ∘∘ | ∘∘ |
| Example 5 | ∘ | ∘ | ∘∘ |
| Example 6 | ∘∘ | ∘∘ | ∘∘ |
| Example 7 | ∘∘ | ∘ | ∘ |
| Comparative | ∘ | ∘ | x |
| example 1 | | | |
| Comparative | x | x | ∘∘ |
| example 2 | | | |

TABLE 2

| | Contact | Solder | Coefficient of |
|---|---|---|---|
| | resistance | wettability | kinetic friction |
| Example 8 | ∘∘ | ∘∘ | ∘∘ |
| Example 9 | ∘∘ | ∘∘ | ∘ |
| Example 10 | ∘∘ | ∘∘ | ∘∘ |
| Example 11 | ∘ | ∘∘ | ∘ |
| Example 12 | ∘ | ∘∘ | ∘∘ |
| Example 13 | ∘ | ∘∘ | ∘ |
| Example 14 | ∘ | ∘ | ∘ |
| Comparative | ∘ | ∘∘ | x |
| example 3 | | | |
| Comparative | x | x | ∘∘ |
| example 4 | | | |

As shown in Tables 1 and 2, the Comparative examples 1 to 4 were unacceptable in at least one item among the contact resistance, the solder wettability, and the coefficient of kinetic friction. Contrary to the above, the Examples 1 to 14 each satisfied the acceptability criteria for all of the items of the contact resistance, the solder wettability, and the coefficient of kinetic friction. Thus, the Examples 1 to 14 were favorable as metallic materials for connectors.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2008-072545 filed in Japan on Mar. 19, 2008, and Patent Application No. 2008-072546 filed in Japan on Mar. 19, 2008, each of which is entirely herein incorporated by reference.

1. A metallic material for a connector, having a base material of a bar material or a rectangular wire material formed of copper or a copper alloy, wherein a striped copper-tin alloy layer is formed in the longitudinal direction of the metallic material on a part of the surface of the metallic material, and wherein a tin layer or a tin alloy layer is formed on the remaining part of the surface of the metallic material.

2. The metallic material for a connector according to claim 1, wherein a nickel layer or a nickel alloy layer is formed on the base material.

3. The metallic material for a connector according to claim 1, wherein a copper layer or a copper alloy layer is formed as an under layer of the tin layer or the tin alloy layer.

4. The metallic material for a connector according to claim 3, wherein a nickel layer or a nickel alloy layer is formed on the base material.

5. A metallic material for a connector, having: a base material of a bar material or a rectangular wire material formed of copper or a copper alloy; and a tin layer or a tin alloy layer formed on the surface of the base material, wherein the thickness of the tin layer or the tin alloy layer varies in a stripe form in the transverse direction of the metallic material, and wherein a copper-tin alloy layer is formed as an under layer at least the area where the thickness of the tin layer or the tin alloy layer is thin.

6. The metallic material for a connector according to claim 5, wherein a nickel layer or a nickel alloy layer is formed on the base material.

7. The metallic material for a connector according to claim 5, wherein a copper layer or a copper alloy layer is formed as an under layer of the tin layer or the tin alloy layer.

8. The metallic material for a connector according to claim 7, wherein a nickel layer or a nickel alloy layer is formed on the base material.

9. A method of producing a metallic material for a connector, comprising: providing a bar material or a rectangular wire material of copper or a copper alloy as a base material; forming a tin plating layer or a tin alloy plating layer on the base material, to obtain an intermediate material; and subjecting the intermediate material to reflow treatment in a stripe form in the longitudinal direction of the intermediate material.

10. The method of producing a metallic material for a connector according to claim 9, wherein the reflow treatment is carried out by laser beam irradiation.

11. The method of producing a metallic material for a connector according to claim 9, wherein the reflow treatment is carried out, to expose the copper-tin alloy partially at the surface.

12. The method of producing a metallic material for a connector according to claim 11, wherein the reflow treatment is carried out by laser beam irradiation.

13. The method of producing a metallic material for a connector according to claim 11, wherein the thickness of the tin plating layer or the tin alloy plating layer before subjecting to the reflow treatment is 0.3 to 0.8 μm.

14. The method of producing a metallic material for a connector according to claim 13, wherein the reflow treatment is carried out by laser beam irradiation.

15. The method of producing a metallic material for a connector according to claim 11, wherein the intermediate material is obtained, by providing a copper plating layer or a copper alloy plating layer between the base material and the tin plating layer or the tin alloy plating layer, or by providing, on the base material, a nickel plating layer or a nickel alloy plating layer, and a copper plating layer or a copper alloy plating layer, from the side nearer to the base material.

16. The method of producing a metallic material for a connector according to claim 15, wherein the reflow treatment is carried out by laser beam irradiation.

17. The method of producing a metallic material for a connector according to claim 15, wherein the thickness of the tin plating layer or the tin alloy plating layer before subjecting to the reflow treatment is 0.3 to 0.8 μm, and wherein the ratio (Sn thickness/Cu thickness) of the thickness of the tin plating or tin alloy plating layer (Sn thickness) to the thickness of the copper plating layer (Cu thickness) is less than 2.

18. The method of producing a metallic material for a connector according to claim 17, wherein the reflow treatment is carried out by laser beam irradiation.

19. The method of producing a metallic material for a connector according to claim 9, wherein the reflow treatment is carried out, to form a copper-tin alloy layer, thereby to reduce the thickness of the tin plating layer or the tin alloy plating layer.

20. The method of producing a metallic material for a connector according to claim 19, wherein the reflow treatment is carried out by laser beam irradiation.

21. The method of producing a metallic material for a connector according to claim 19, wherein the thickness of the tin plating layer or the tin alloy plating layer before subjecting to the reflow treatment is 0.8 to 1.2 μm.

22. The method of producing a metallic material for a connector according to claim 21, wherein the reflow treatment is carried out by laser beam irradiation.

23. The method of producing a metallic material for a connector according to claim 19, wherein the intermediate material is obtained, by providing a copper plating layer or a copper alloy plating layer between the base material and the tin plating layer or the tin alloy plating layer, or by providing, on the base material, a nickel plating layer or a nickel alloy plating layer, and a copper plating layer or a copper alloy plating layer, from the side nearer to the base material.

24. The method of producing a metallic material for a connector according to claim 23, wherein the reflow treatment is carried out by laser beam irradiation.

25. The method of producing a metallic material for a connector according to claim 23, wherein the thickness of the tin plating layer or the tin alloy plating layer before subjecting to the reflow treatment is 0.8 to 1.2 μm, and wherein the ratio (Sn thickness/Cu thickness) of the thickness of the tin plating or tin alloy plating layer (Sn thickness) to the thickness of the copper plating layer (Cu thickness) is 2 or greater.

26. The method of producing a metallic material for a connector according to claim 25, wherein the reflow treatment is carried out by laser beam irradiation.
